(19) United States
(12) Patent Application Publication
(10) Pub. No.: US 2025/0042127 A1
(43) Pub. Date: Feb. 6, 2025

(54) CARBON FIBER COMPOSITE LATTICE ARTICLES AND METHODS TO FORM THEM

(71) Applicant: DowAksa USA, LLC, Midland, MI (US)

(72) Inventors: David Bank, Midland, MI (US); Ramki Subramanian, Midland, MI (US)

(21) Appl. No.: 18/715,824

(22) PCT Filed: Dec. 2, 2022
(86) PCT No.: PCT/US2022/051646

§ 371 Date: Jun. 3, 2024

Related U.S. Application Data
(60) Provisional application No. 63/391,351, filed on Jul. 22, 2022.
(60) Provisional application No. 63/286,319, filed on Dec. 6, 2021.

(51) Int. Cl. B32B 5/12; B32B 5/18; B32B 5/24; B32B 7/12

(52) U.S. Cl. CPC B32B 5/12; B32B 5/18; B32B 5/245; B32B 7/12; B32B 2260/023; B32B 2260/046; B32B 2262/106; B32B 2264/10; B32B 2264/2032; B32B 2264/303; B32B 2307/546; B32B 2307/7376; B32B 2307/748; B32B 2605/00

(57) ABSTRACT

An article is comprised of at least two longitudinal members and a transverse member, wherein the longitudinal members and transverse member are a continuous carbon fiber polymer (CCFP) composite interconnected by the transverse member, the transverse member being joined to each of the longitudinal members by a lap or mortise and tenon joint. The continuous carbon fiber may form complex shapes that may be capped to form articles such as airfoils, walls and floors. The continuous carbon fiber polymer composite may be a laminate of a monolithic pultruded CCFP composite and a polylithic pultruded CCFP composite.

### FIELD

The invention relates to forming load bearing articles comprised of continuous fiber members. In particular, the invention relates to load bearing articles comprised of continuous carbon fiber members assembled into a lattice structure.

### BACKGROUND

Over many years in the building construction industry there has been a continuing shift from the use of natural materials (e.g., wood) to metal and engineered wood products for structural applications. Likewise, there has been a similar trend to replace steel with lighter weight aluminum, fiber glass/polymer composite and carbon fibers polymer composites in the transportation industry. For example, many body in white panels and inside trim pieces have employed laminated woven carbon fiber composites for strengthening certain members such as body pillars and the like. In certain applications, whole monocoques have been formed of woven carbon fiber polymer composites (e.g., formula 1 racing vehicles). Likewise, fuselages of aircraft have been made of woven carbon fibers. These uses of carbon fiber composites have tended to be used as patches to improve the performance of the existing material due to cost and difficulty in fabrication or for particular applications where weight and performance is of paramount importance (Formula 1 race cars and Aircraft e.g., “Boeing DREAMLINER”). These, however, have suffered from the expense and difficulty in processing the fiber composites and curing of the polymer without defects. Likewise, selective use of laminated fiber composites have been used for windmill turbine blades spars and load bearing sections of the blade.

Load bearing floors or members in the building industry have tended to be formed from wood beams that have been fastened together with nails or steel beams that have been bolted together to form a load bearing structure. In the automotive industry frames and the like have typically been formed from welded steel tubes. More recently to expand, for example, the use of wood to build taller buildings, engineered wood composites have been used to increase the load bearing and reduce the weight for a given span. Likewise, aluminum has been utilized to reduce weight in automobile frames and body panels such as in Ford pick-up trucks.

Accordingly, it would be desirable to further decrease the weight and cost to make structural load bearing articles for use in the transportation, construction and energy applications.

### SUMMARY

Applicants have discovered that pultruded continuous carbon fiber polymer composite sheets may be formed into lattices structures that may have complex contours aiding in the formation of load bearing articles with complex external shapes (e.g., airfoils).

A first aspect of the invention is an article comprised of at least two longitudinal members and a transverse member, wherein the longitudinal members and transverse member are a continuous carbon fiber polymer composite interconnected by the transverse member, the transverse member being joined to each of the longitudinal members by a lap or mortise and tenon joint.

### DESCRIPTION OF THE DRAWING

FIG. 1 is a is perspective view of an article of this invention.

FIG. 2 is a perspective view of an article of this invention.

FIG. 3 is a perspective view of an article of this invention.

FIG. 4 is a perspective view of an article of this invention.

### DETAILED DESCRIPTION

The explanations and illustrations presented herein are intended to acquaint others skilled in the art with the invention, its principles, and its practical application. The specific embodiments of the present disclosure as set forth are not intended to be exhaustive or limit the scope of the disclosure.

One or more as used herein means that at least one, or more than one, of the recited components may be used as disclosed. It is understood that the functionality of any ingredient or component may be an average functionality due to imperfections in raw materials, incomplete conversion of the reactants and formation of by-products.

The members of the article are comprised of a continuous carbon fiber polymer (CCFP) composite. The CCFP may be further comprised of fibers other than carbon fibers. Other useful fibers that may be used in the CCFP may include any suitable, such as those known in the art with examples, being naturally occurring fibers (e.g., hemp, bamboo, jute, sisal, and coconut) metal fibers and glass fibers. When present such other fibers may be present in any suitable amount depending on the desired characteristics, but typically are present in an amount of about 1%, 5%, 10% or 20% to about 99%, 95%, 75%, or 50% by volume of the fibers present in the CCFP composite with the balance being carbon fibers.

The CCFP may be any that enables the desired weight, cost and mechanical characteristics of the article. The CCFP may be woven (e.g., bidirectional) or unidirectional. Often, unidirectional continuous carbon rovings pultruded into a ribbons or sheets with a thermoset or thermoplastic resin is used to form the members the article. The use of a ribbon or sheet with the carbon fibers parallel to the pultrusion direction allows for the formation of lattices which may have simple or complex shapes when capped with an outer layer (cap).

The continuous carbon fiber polymer composite (CCFP composite) may be any suitable such as those known in the art. For example, the carbon fiber may one that is derived from any material that may be processed into a filament of desired size and carbonized. Typically, for carbon fibers, petroleum based pitches, polyamide or polyacrylonitrile may be used. The production of carbon fibers is well known with the following U.S. Pat. Nos., being illustrative: U.S. Pat. Nos. 3,294,489, 3,595,946, and 3,461,082. The fibers may be any useful diameter and typically may be from about 1 micrometer to 20, 50 or 100 micrometers in diameter. Examples of suitable fibers include those available from DowAksa under the tradename AKSAKA and from Toray Industries under the tradename ZOLTEK.

The polymer of the CCFP composite may be formed from a thermoplastic resin or polymer or thermosetting resin. Resin is used herein to denote that further curing or polymerization may occur when forming the CCFP, for example by pultruding. The thermoplastic materials as described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material.

The thermoset materials as described herein generally encompass a plastic material or polymer that is non-reversible in nature. For example, thermoset materials, once cured, cannot be easily remolded or returned to a liquid state. As such, after initial forming, thermoset materials are generally resistant to heat, corrosion, and/or creep. Example thermoset materials may generally include, but are not limited to, polyesters, polyurethanes including polyurethanes having polyurea, esters, epoxies, or any other suitable thermoset material. Desirably, the polymer is comprised of polyurethane or epoxy. Exemplary thermosetting resins may include those described in U.S. Pat. Nos. 4,604,435 and 4,663,397, and a polyurethane resin-acrylate resin described in U.S. Pat. Appl. No. 2019/0375882, each incorporated herein by reference.

The CCFP composite typically has an amount of fibers sufficient to realize the load bearing capabilities and weight desired in the article. Typically, the amount of fibers is from about 20%, 30 or 50% to 70% or 80% by volume of the CCFP composite. The CCFP composite may be any shape such as those that may be produced by pultrusion (e.g., sheet, ribbon, tape, tubes, slitted tubes or rods) and as described in U.S. Pat. Publ. Nos. 2007/0117921 and 2018/0272566.

The CCFP composite may also be comprised of other additives for imparting one or more desired characteristics. Examples, of other additives include fillers such as the fillers described herein below for use in adhesives and as follows: mica, talc, clay minerals (e.g., kaolin, bentonite, smectite, montmorillonite), wollastonite, silica, calcium carbonate, glass beads, glass flakes, glass microballoons, molybdenum disulfide, titanium oxide, zinc oxide, antimony oxide, calcium polyphosphate, graphite, barium sulfate, magnesium sulfate, zinc borate, calcium borite, aluminum borate whisker, potassium titanate whisker, and high-molecular compounds. Other additives may include conductivity-imparting materials such as metal-based materials, metallic oxide-based materials, carbon black, and graphite powder; halogen-based flame retardants such as a brominated resin; antimony-based flame retardants such as antimony trioxide and antimony pentoxide; phosphorus-based flame retardants such as polyphosphate ammonium, aromatic phosphate, and red phosphorus; organic acid metallic salt-based flame retardants such as organic metal borate, metal carboxylate, and aromatic sulfonimide metallic salt; inorganic flame retardants such as zinc borate, zinc, zinc oxide, and zirconium compounds; nitrogen-based flame retardants such as cyanuric acid, isocyanuric acid, melamine, melamine cyanurate, melamine phosphate, and nitrogenated guanidine; fluorine-based flame retardants such as PTFE; silicone-based flame retardants such as polyorganosiloxane; metallic hydroxide-based flame retardants such as aluminum hydroxide and magnesium hydroxide; other flame retardants; flame retardant aids such as cadmium oxide, zinc oxide, cuprous oxide, cupric oxide, ferrous oxide, ferric oxide, cobalt oxide, manganese oxide, molybdenum oxide, tin oxide, and titanium oxide; pigments; colorants; lubricants; release agents; compatibilizers; dispersing agents; crystalline nucleus agents such as mica, talc, and kaolin; plasticizers such as phosphate ester; thermal stabilizers; antioxidants; color protectors; UV stabilizers; fluidity modifiers; foaming agents; antibacterial agents; vibration dampers; and antistatic agents such as polyether esteramide.

The other additives may include sizing agents such as those known in the art and may include resins of polyurethane, polypropylene, polyethylene, polycarbonate, polyetherimide, siloxane resins, polyketones, polysulfone, polyethersulfone, polyetheretherketone, polyetherketoneketone, polyphenylenesulfide, polyacrylates, polyvinylacetates, polyamide, polyesters, polyetherimide, polyamines, polyimides, epoxy resins, phenoxy resins, melamine resins, urea resins, polyamideimides, polyethersulfones, polyetheretherketones, polyetherketoneketones, polyphenylenesulfides and combinations thereof or precursors thereof that may be polymerized after being contacted with the carbon fiber or upon pultrusion with the polymer of the CCFP composite. The sizing agent may be an epoxy compound or adduct or isocyanate compound or adduct such as those described in U.S. Pat. Nos. 3,957,716; 10,501,605; and 11,118,022, each incorporated herein by reference.

The amount of other additives may be any useful amount for imparting a desired characteristic of the CCFP composite. Typically, the amount of other additives may be an amount of about 0.1% or 1% to about 50%, 40%, 30% or 20% by volume of the CCFP composite.

Typically, it is desirable for the CCFP to be in a shape of a flat sheet, ribbon or tape with a width/thickness ration of at least about 2, 5 or 10 to any practically useful ration such as 200 or 100. Particularly suitable CCFP composites include those produced using a thermosetting resin and in particular ones comprised of polyurethane produced by a method such as described in U.S. Pat. Appl. No. 2018/0272566 employing the aforementioned polyurethane resin and commercially available polyurethane resins available from The Dow Chemical Company. Suitable CCFP pultruded composites, where polyurethane is the reinforcing polymer, are available from DowAksa. Any pultrusion process may be used such as those known in the art, with some examples being U.S. Pat. Nos. 4,643,126; 4,680,224; and 4,720,366.

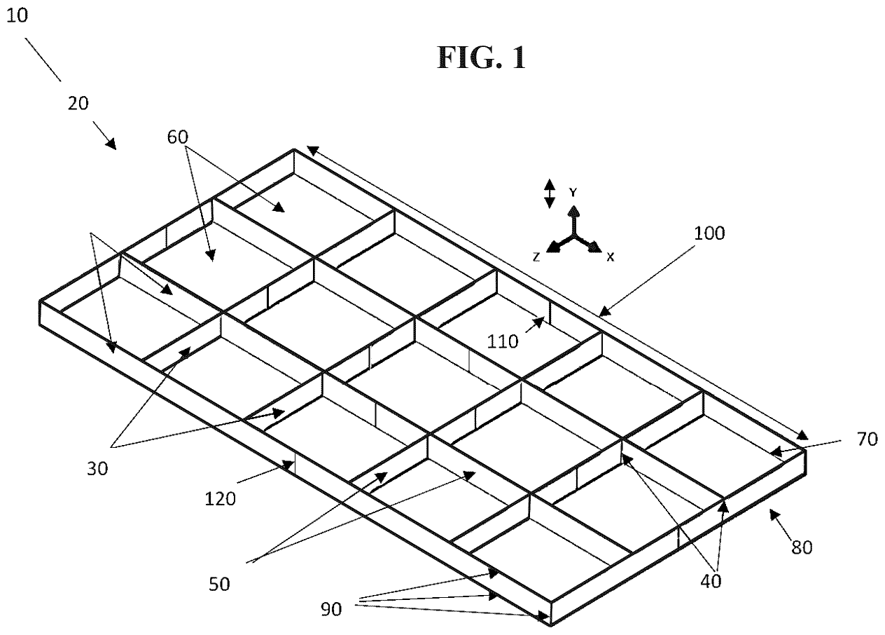

The article of the invention has at least two longitudinal members and a transverse member interconnecting the longitudinal members by a lap or mortise or tenon joint. The designation of longitudinal or transverse is merely used to indicate relationship between the members and is not limiting in any way. FIG. 1 shows an embodiment of the invention 10 (lattice) to illustrate the invention. The longitudinal members 20 and transverse members 30 are interconnected by joints 40. The faces 50 of the members 20 and 30 form cavities 60 that are open at the top 70 and bottom 80 of the lattice defined by edges 90. The carbon fibers not pictured of each member may be parallel to the length 100 of each longitudinal member 20 and transverse member 30. Each width 110 of the transverse members 30 may be parallel, however may not need to be so depending on the load characteristics desired. Likewise, each width 110 of the longitudinal members may be parallel. The transverse members width 110 may also be parallel. It is also desirable that the widths 110 of the transverse members 30 are parallel with each other as well as being parallel with the widths 110 of the longitudinal members 20.

The joints 20 are either a lap joint or mortise and tenon joint. The lap joint may be a half lap joint or mortise and tenon joint where each width 110 of the longitudinal member 20 and transverse member 30 has an equivalent amount of material removed along its width to form the joint 40 while maintaining a consistent width 110. The lap or mortise and tenon joint may be interlocking mechanically constraining movement, for example, along the length direction of one the members 20 or 30. Such interlocking joints may be, for example, those having a puzzle piece or dove tail interlocking geometry.

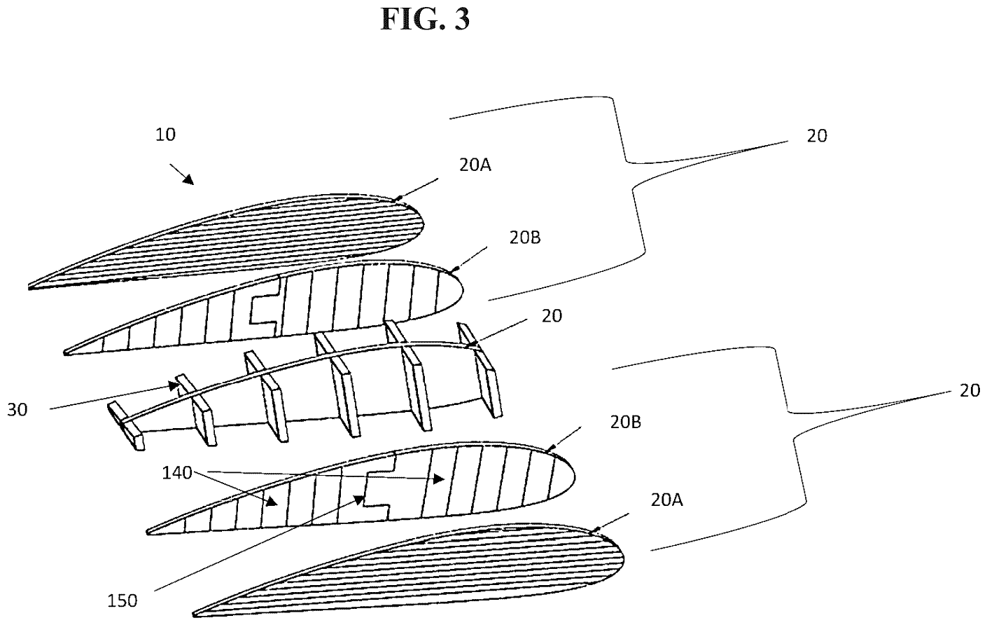

The fibers of the CCFP of the article generally lie in the same plane. That is at least a portion of the continuous fibers are parallel with the length 100 of each member. All of the carbon fibers may lie in the same plane. A portion of a member 20 or 30 may be a laminate of more than one CCFP composite where a portion of the fibers are parallel with the length 100 and a portion of the fibers at an angle that deviates from parallel (e.g., at an acute angle or orthogonal to the length 100), which is illustrated in FIG. 3.

In FIG. 3 a rib defining the outer shape of an airfoil, longitudinal members 20 may be made up of two layers 20A and 20B (shown separated for illustration purposes and not attached to the transverse members 30 of the lattice 10). The straight lines on each layer 20A and 20B show the lie of the carbon fibers of the CCFP composite. Layer 20A is monolithic (e.g., from the same pultrusion formed CCFP composite). Layer 20B is polylithic where, in this instance, each CCFP composite piece 140 is joined by an interlocking joint 150 that may or may not be adhered with an adhesive as described in herein. The interlocking joint 150 means, in the absence of an adhesive, mechanically restricts motion in at least one direction (e.g., the stub tenon joint shown), but desirably is one that restricts motion in two directions (e.g., puzzle or dovetail joint).

When laminating layers any known laminating process may be used. Typically, when laminating an adhesive as described herein is applied to at least a portion of the layer's faces and pressed to abut the layers 20A and 20B together with sufficient pressure to realize the desired thickness of the interposed adhesive. The pressure may be sufficient to penetration of the joint 150 thereby adhering

The joints may be mortise and tenon joint or lap joints. To realize each member being contiguous those joints 40 where longitudinal 20 and transverse 30 members traverse each other, the joint is a through lap joint, with it being desirable that the lap joint is a ½ lap joint. Where the joint terminates one member 20 or 30, the joint typically is either a lap joint or mortise and tenon joint. Depending, on the thickness (not numerically depicted, but is the orthogonal distance between faces 50 of each member 20 or 30), it may be desirable for the lap or mortise and tenon joint to have further interlocking such as dove tail or jigsaw geometry depending on the load bearing that may be encountered in particular applications (e.g., shear, compression and bending).

Each member 20 and 30 may be made of a monolithic CCFP or may be comprised of laminates of multiple CCFP composites. The use of laminates may be desirable to realize desirable performance with making CCFP composites that have a thickness that is thin allowing for efficient penetration of the polymer of the CCFP composite avoiding costly penetration and workup of the composite. Likewise, it allows for the design of members 20 or 30 that may have desirable multi-directional load bearing characteristics without the inefficiency of woven fiber composites and processing issues arising therefrom (e.g., polymer penetration of the woven thicker fiber composite). The laminate may have a CCFP composite that is a monolith with all the CCFP essentially parallel with the length of the member 20 or 30 and a CCFP composite that is adhered to the monolithic CCFP that is comprised of multiple separate CCFPs that have been interlocked and adhered to each other as well as the monolithic CCFP. Likewise, each member member 20 or 30 may be comprised of two or more CCFP composites that are interlocked 120 and adhered if desired.

The cavities 60 of the lattice 10 may be filled with a foam. A foam is as commonly understood in the art meaning a body that is cellular. Cellular (foam) herein means the body has a substantially lowered apparent density compared to the density of the body's material (e.g., polymer, ceramic or metal) and the body is comprised of cells that are closed or open. Closed cell means that the gas within that cell is isolated from another cell by the polymer walls forming the cell. Open cell means that the gas in that cell is not so restricted and is able to flow to another cell without passing through any polymer cell walls to the atmosphere.

The size of the cells may be any useful size depending on the characteristics desired. Illustratively, the cells of the foam may have an average size (largest dimension) of 0.05 to 5.0 mm, especially from about 0.1 to about 3.0 mm, as measured by ASTM D-3576-98. Foams having larger average cell sizes, of especially about 1.0 to about 3.0 mm or about 1.0 to about 2.0 mm in the largest dimension, may be of particular use in load bearing applications.

Generally, the foam may have a density from about 16 kg/m³ to about 100 kg/m³ or more. The foam density, typically, is selected depending on the particular application, for example, for an exterior building façade panel, the density is desirably 24 kg/m³ to about 64 kg/m³.

The foam may adhere two or more of the members 20 and 30 together. The foam may be isolated in each cavity 60. The foam may be in communication between two or more cavities via a throughway traversing the thickness of a member. The throughway may be a notch or hole of any geometry or configuration (e.g. rectangular notch or hole). The foam may form a continuous matrix (foam in and between throughways connecting two or more cavities).

Typically, the foam is a polymer foam, but need not be. The foam typically has a porosity of at 30% or 50% to any practically useful porosity such as 95%. The foam may, for example, be an inorganic (metal or ceramic) foam, cement, aerogel or porous body. An adhesive may be used to bond those foams having insufficient adhesion to the members of the lattice. The adhesive may be any suitable adhesive such as anyone or more of those described herein.

The foam may have any amount of open or closed cells. Even so, for some applications a portion of the cells may be closed, for example, when absorption of water is deleterious to the function of the final product. Even though open or closed foams may be used, when the application desired benefits from lack of water absorption, the foam is preferably closed cell. For such applications, it is preferred, that at least about 55%, more preferably at least about 60%, even more preferably at least about 75% and most preferably at least about 90% of the cells of the foam are closed cells.

The polymer foam may be a thermoplastic or thermoset polymer foam. Any polymer that may be made into a foam may be used. Illustratively, the foam may be a polyurethane, polyurea, polyolefin, polyester, polycarbonate, polyacrylate, polyether, polyvinyl (e.g., polystyrene), polyvinylidene, polyetherester or any combination thereof. An illustration is the use of a polyurethane foam that is foamed into the cavities and allowed to expand to the portion of the cavity desired to be filled.

At the joints, the members may be further interlocked by an adhesive. The adhesive thickness (shortest distance between members through the adhesive) may be any useful thickness, but desirably is from 0.025 or 0.05 mm to 1 mm or 3 mm. The adhesive may have one or more fillers. When the materials have polar groups at their surface, the adhesive may be comprised of, for example, an epoxy, urethane, urea, formaldehyde, acrylate, silicone or any combination thereof. In some instances to realize the desired load bearing, the adhesive desirably has a lap shear of at least 5, 10 or 20 N/mm² at 20° C. or 40° C., wherein the lap shear is measure in accordance with ISO 4587.

Epoxy is an illustration of the adhesive. The epoxy may be any comprised of an epoxy resin and a curing agent. The epoxy adhesive may be one that has a latent curing agent (or “hardner”) or is a two-part epoxy where the curing agent and epoxy resin are mixed upon application. Another illustration is two component methacrylate adhesives such as those described by U.S. Pat. Nos. 4,536,546 and 9,657,203 and PCT Appl. No. WO2008057414, which may also be comprised of epoxy compounds.

The epoxy resin may be saturated or unsaturated, aliphatic, cycloaliphatic, aromatic or heterocyclic and may be substituted. The epoxy resin may also be monomeric or polymeric. An extensive enumeration of epoxy resins useful in the present invention is found in Lee, H. and Neville, K., “Handbook of Epoxy Resins.” McGraw-Hill Book Company, New York, 1967, Chapter 2, pages 257-307; incorporated herein by reference. The epoxy resins may be reaction products of polyfunctional alcohols, phenols, cycloaliphatic carboxylic acids, aromatic amines, or aminophenols with epichlorohydrin. A few examples include bisphenol A diglycidyl ether, bisphenol F diglycidyl ether, resorcinol diglycidyl ether, and triglycidyl ethers of para-aminophenols. Other possible epoxy resins include reaction products of epichlorohydrin with o-cresol and, respectively, phenol novolacs. Further epoxy resins include epoxides of divinylbenzene or divinylnaphthalene. It is also possible to use a mixture of two or more epoxy resins. The epoxy resins may be selected from commercially available products such as those under the tradenames D.E.R. and D.E.N. available from Olin Chemical or Syna 21 cycloaliphatic epoxy resin from Synasia.

The curing agent may be any that has active chemical moiety that is reactive with the epoxy group of the epoxy resin. Any curing agent may be used alone or in combination with other curing agents. The curing agent may be any such as those known in the art. Examples include phenol-containing compounds, amines and combinations thereof. Illustratively, the curing agent may be primary and secondary polyamines and their adducts and polyamides. For example, polyfunctional amines may include aliphatic amine compounds such as diethylene triamine (D.E.H. 20, available from Olin Chemical), triethylene tetramine (D.E.H. 24, available from Olin Chemical), tetraethylene pentamine (D.E.H. 26, available from Olin Chemical), as well as adducts of the above amines with epoxy resins, diluents, or other amine reactive compounds. Aromatic amines such as metaphenylene diamine and diamine diphenyl sulfone, aliphatic polyamines, such as amino ethylpiperazine and polyethylenepolyamine, and aromatic polyamines such as metaphenylene diamine, diamino diphenyl Sulfone, and diethyltoluene diamine, may also be used as the curing agent. The curing agents may contain a sterically hindered amine group wherein an alkyl, cycloalkyl or aralkyl group is in close proximity to the amine group so that it is less reactive than in the case where the alkyl, cycloalkyl or aralkyl group is absent. An example of a curing agent having hindered amine groups are polyetheramines (for example, Jeffamine D-230 available from Huntsman Chemical), isophorone diamine (for example, Vestamin IPD from Evonik), bis(4-amino-3-methylcyclohexyl) methane (for example, Laromin C-260 from BASF). Further exemplary epoxy resins and hardner are described in U.S. Pat. Publ. No. 2010/0151138 from paragraph 51 to 86, incorporated herein by reference.

The epoxy adhesive may be further comprised of other agents or additives to impart a desired result. For example, a toughener may be added. Examples of toughening agents include rubber particles. Examples and the amounts of toughening agents that may be suitable include those described in paragraphs 20 to 25 of U.S. Pat. Publ. No. 2015/0368457, incorporated herein by reference. The amount of additives may be any useful amount. Typically, the amount of additives is from 10% to 70% by volume of the adhesive.

The adhesive may incorporate other additives for a desired characteristic. For example, other useful additives may include, non-reactive diluents, stabilizers, surfactants, flow modifiers, pigments or dyes, matting agents, degassing agents, flame retardants (e.g., inorganic flame retardants, halogenated flame retardants, and non-halogenated flame retardants such as phosphorus-containing materials), curing initiators, curing inhibitors, wetting agents, colorants or pigments, thermoplastics, processing aids, UV blocking compounds, fluorescent compounds, UV stabilizers, inert fillers, fibrous reinforcements, antioxidants, impact modifiers including thermoplastic particles, and mixtures thereof.

The fillers may be those conventionally used in adhesives. Illustrative examples include particulate ceramics such as, inorganic glass (e.g., beads and hollow beads), silicates (e.g., talc), clays, alumino-silicates (e.g., mullite), oxides (e.g., titanium dioxide, silica, calcium oxide, magnesium oxide and alumina), carbon (e.g., amorphous and graphitic) and metal powders. The fillers may be pretreated such as drying to remove moisture. The filler may have any useful size and, in some instances when a particular thickness of adhesive is desired, the size may be monosized (e.g., glass beads where at least 90% of the particles are within ±10% of the average diameter of the glass beads). The amount of filler typically is from 10% to 60% by volume of the adhesive. The size of the filler may be any useful. Typically, the size is from 5, 10 or 20 micrometers to 100, 250, or 500 micrometers.

Polyurethane is another example of an adhesive. The polyurethane adhesive may be any known in the art and include those commercially available from Titebond and The Gorilla Glue Company. Likewise, a urea formaldehyde glue may be used such as available under the tradename Unibond 800. Exemplary urethane compounds useful in urethane adhesives are described in paragraphs 27 to 37 of U.S. Pat. Publ. No. 2010/0151138, incorporated herein by reference. In some instances, the polyurethane is further comprised of urea linkages due to the substitution of some of the polyols with a polyamine.

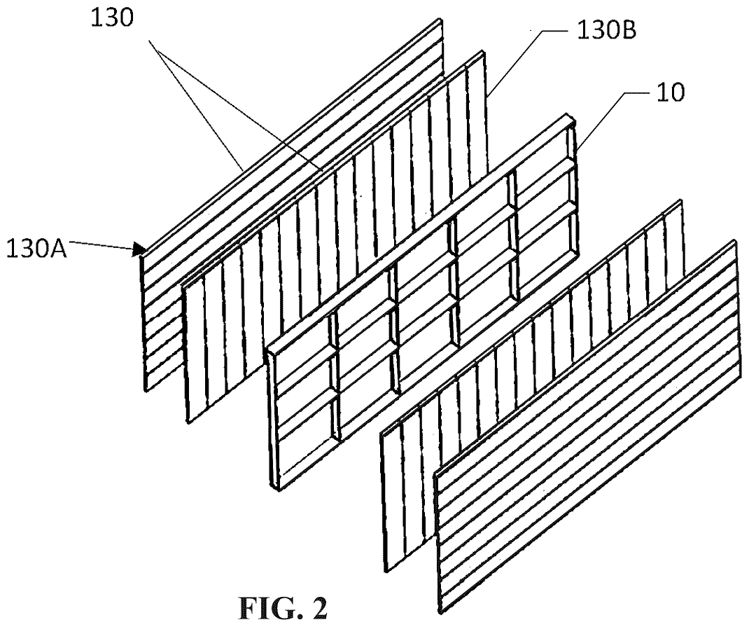

The lattice 10 as shown in FIG. 2 depicts a cap 130 made up of two layers 130A and 130B (shown detached from the lattice 10). The cap 130 may enclose any portion of any cavity, with fully enclosing all the cavities at least on one side of the lattice. In FIG. 3, the cap 130 is comprised of two engineered wood layers 130A and 130B having different cellulosic strand orientations.

The cap may be a floor, fascia (e.g., drywall, shingles and siding), skin (e.g., airfoil surface). The cap may be comprised of any useful material depending on the desired application. For example, the cap may be comprised of a cellulosic material (e.g., wood, engineered lumber, and wood composites), metals (e.g., Mg, Al, Fe, Ti, or an alloy comprised of one of the aforementioned), polymers, fiber polymer composites, and ceramics (e.g., cements) and any composites, laminates, and structures comprised of 2 or more of the aforementioned. The cap may have a foam core. The foam may be one of those previously described herein. The lattice or article may be particularly useful for a component of a trailer, vehicle frame, or vehicle body (e.g., body panels, interior panels, bumpers, fenders, quarter panels and the like). For example, such parts may be made by a thermoforming process where a thermoformed polymer sheet is a cap over the lattice enveloped by the foam within the cells described herein. The thermoformed polymer sheet may be any polymer capable of thermoforming such as thermoplastic materials (thermoplastic polymers) described herein, which may also be comprised of a fiber, filler or other additives such as those described herein, however, the fiber may also be chopped as commonly understood in the art (e.g., from about 0.5 mm to 10 mm in length). The cap layer may also be made of a thermoset material described herein where liquid or paste reactants are cast or pressed upon a mold, which may also be comprised of fibers, fillers or other additives.

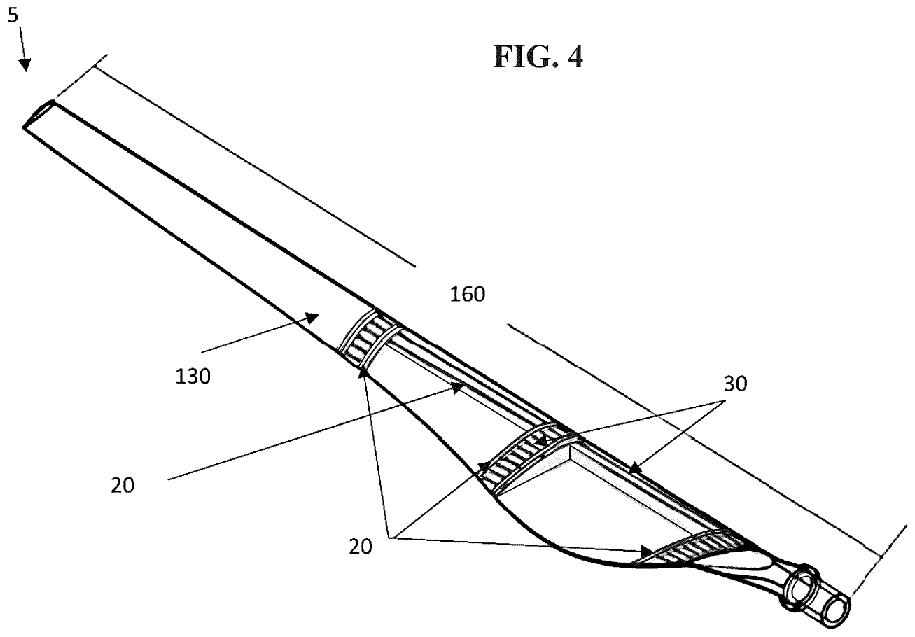

Desirably, the cap may be comprised of a fiber polymer composite such as one described herein that forms the surface of an airfoil such as depicted in FIG. 4, which may have a further top applied thereto to realize, for example the desired airflow characteristics.

As a further illustration, the cap may also be formed by twin sheet thermoforming of two thermoplastic sheets that are, for example, heated to a temperature where they are moldable by a force (e.g., vacuum) to opposing mold surfaces and then joined, wherein the lattice is interposed between the sheets adding desired structural properties. The internal cavity formed by the two thermoformed sheets having the lattice interposed between them may have a foam injected into the cavity to introduce further desired characteristics (e.g., mechanical, acoustical and thermal properties). The cavity may be comprised of cavities that are created as a consequence of the twin sheet thermoforming process and the foam may be injected in a portion of the cavity or cavities depending on the desired characteristics.

In FIG. 4, the lattice 10 (only showing a portion of the lattice that runs essentially the length of the airfoil 5 is made of longitudinal members 20 and transverse members 30 in which two transverse members run essentially the length or large portion of the airfoil length 160 and the other transverse members 30 on run smaller portion of the airfoil length 160. Longitudinal members 20, as shown, is a laminate where the CCFP composite is sandwiched between two layers of engineered lumber. The longitudinal members 20 define the shape of the airfoil 5 and support cap 130 that is adhered to the lattice 10.

The CCFP composites making up the members or parts of the members may be machined by conventional techniques and depending on complexity due the unique characteristics, the shapes, including the joints, may be done by water jetting or abrasive water jet machining.

### ILLUSTRATIVE EMBODIMENTS

### Example 1

5 mm thick and 120 mm thick CCFP polymer composites having about 70% by volume carbon fibers and a polyurethane polymer matrix available from DowAksa are cut into 4 longer members (˜1,220 mm length) and 5 shorter members (˜610 mm). The carbon fibers lie parallel to the length of each member. Each member is milled with a table saw to form 5 mm wide by 60 mm deep slits in the width of each long member at equidistant intervals (about 200 mm) along the length. The short members have 4 slits where the 2 slits are about 20 mm from the end of the short member and the two other slits are equidistant from each end so as to form lattice cells of about 200 mm square cells. The long members have 5 slits and the short members have 4 slits. The slits of the long members and short members are interconnected (through lap joints) to form a rectangular lattice having approximately square lattice cells as in a similar manner as depicted in FIG. 1, except that the cells at ends of the long members are not enclosed by a short member. At each lap joint two component Henkel Loctite AA H4500 adhesive is applied between the interconnected members and clamped until cured. In the center of each interior lattice cell wall a ¼ inch hole is drilled to allow the flow of a polyurethane foam between the cells. The lattice is set upon a sacrificial removal film and the interior cells filled with DuPont Great Stuff Pro Series Gaps & Cracks Polyurethane closed cell polyurethane foam that fills and is in communication between each of the interior cells and excess flows out of the holes drilled through the outer walls relieving pressure of the foam. After foaming and removal of the sacrificial film, a top cap comprised of a 1220 mm×620 mm×5 mm unidirectional epoxy carbon fiber composite is adhered using the same aforementioned adhesive to one side of the foam filled lattice to form a floor. The lattice easily bears the load of several people without any observable deflection.

1. An article comprised of at least two longitudinal members and a transverse member, wherein the longitudinal members and transverse member are a continuous fiber polymer composite comprised of carbon fibers interconnected by the transverse member, the transverse member being joined to each of the longitudinal members by a lap joint or mortise and tenon joint, wherein the continuous carbon fiber polymer composite is a sheet having a length parallel to the length of the carbon fibers, a width and thickness perpendicular to the length of the carbon fibers, a ratio of width to thickness of at least about 5, the width and length defining faces of the sheet, the length and thickness defining edges of the continuous carbon fiber polymer composite, the width and thickness defining ends, and the widths of each longitudinal and transverse member are essentially parallel in the article and the longitudinal members and transverse member form a lattice having a plurality of cavities defined by the faces of the longitudinal and transverse members.

2-5. (canceled)

6. The article of claim 1, wherein said composite is comprised of plurality of sheets adhered together at their faces into a laminate.

7-8. (canceled)

9. The article of claim 1, wherein the plurality of cavities is at least partially filled with a foam, and the foam is a polymeric foam.

10-11. (canceled)

12. The article of claim 9, wherein there is at least two cavities and the foam of each cavity is in communication forming a continuous matrix, and the foam flows through a throughway traversing the thickness of the longitudinal and transverse members.

13.-14. (canceled)

15. The article of claim 1, wherein the continuous carbon fiber polymer composite is a pultruded continuous carbon fiber polymer composite, and polymer of the continuous carbon fiber polymer composite is comprised of one or more of an epoxy, polyurethane and polyurea.

16-18. (canceled)

19. The article of claim 1, wherein an adhesive is abutted between the transverse and longitudinal member to form an adhesive layer having an average thickness of about 0.025 mm to 3 mm at the lap or mortise and tenon joint, and the adhesive has a filler having a particle size of 5 to 500 micrometers equivalent spherical diameter.

20. The article of claim 19, wherein the adhesive layer average thickness is 0.05 mm to 1 mm.

21-22. (canceled)

23. The article of claim 19, wherein the filler is a graphite, ceramic, metal or inorganic glass beads, or inorganic glass hollow spheres; the filler is present in an amount of about 20% to 60% by weight of the adhesive; and the adhesive is comprised of one or more of an epoxy resin, acrylate adhesive, and polyurethane adhesive.

24. (canceled)

25. The article of claim 19, wherein the adhesive has an impact peel strength of at least 5 N/mm at a temperature of 40° C., wherein the impact peel strength is measured in accordance with ISO 4587.

26. (canceled)

27. The article of claim 23, wherein the adhesive is the epoxy resin further comprised of toughener.

28. (canceled)

29. The article of claim 19, wherein the adhesive is comprised of urea and urethane.

30. (canceled)

31. The article of claim 1, wherein a cap is attached to the edges covering a portion of one or more of the cavities.

32. (canceled)

33. The article of claim 31, wherein the cap fully encloses the cavities.

34. (canceled)

35. The article of claim 1, wherein the article is a component of a trailer, vehicle frame, airfoil, or vehicle body.

36-39. (canceled)

40. The article of claim 31, wherein the cap is comprised of one or more of a cellulosic material, fiber polymer composite, polymer, metal and ceramic.

41-45. (canceled)

46. The article of claim 1, wherein the article has a bending strength of at least 500 pounds per square inch.

47. (canceled)

48. An article comprised of at least two longitudinal members and a transverse member, wherein the longitudinal members and transverse member are a continuous carbon fiber polymer composite interconnected by the transverse member, the transverse member being joined by an adhesive having a lap shear of 5 N/mm at a temperature of 40° C., wherein the lap shear is measure in accordance with ISO 4587.

49. An article comprised of a laminate comprised of at least two layers with a layer being a monolithic continuous carbon fiber polymer composite and a polylithic continuous carbon fiber polymer composite adhered together, wherein the polylithic continuous carbon fiber polymer composite's carbon fibers and the monolithic continuous carbon fiber polymer composite's carbon fibers lie at an angle greater than 0° to each other.

50. The article of claim 49, wherein the angle is 45° to 90° and the polylithic continuous carbon fiber polymer composite layer has at least one joint that is interlocking.

51. The article of claim 50, wherein the angle is essentially orthogonal.

52-59. (canceled)
